(19) United States
(12) Patent Application Publication
(10) Pub. No.: US 2012/0034797 A1
(43) Pub. Date: Feb. 9, 2012

(54) VEHICLE CONNECTION SYSTEM

(76) Inventor: MARK JARLETT, East Hartford, CT (US)

(21) Appl. No.: 12/849,280

(22) Filed: Aug. 3, 2010

(51) Int. Cl. H01R 3/00

(52) U.S. Cl. 439/162

(57) ABSTRACT

A system for connecting an associated motor vehicle to a utility connection which includes a cable for connection to an associated utility connection having first and

Second axial extremities, a connector for the first axial extremity for connecting to an associated utility connection, a connector for the second axial extremity for connecting to an associated motor vehicle and an elongated flexible member cooperating with an axial section of the cable for supporting and positioning said cable.

### FIELD OF THE INVENTION

The invention has particular application to methods and apparatus for providing connections to a motor vehicle such as a truck or car when the vehicle is stationary. The need for such connections occurs under various circumstances including, but not limited to, power for heating the engine block or engine oil in cold climates; charging one or more batteries in a vehicle; and providing power and communications to recreational vehicles, motor homes and tractor-trailer vehicles such as those that are equipped with sleeping accommodations.

### BACKGROUND OF THE INVENTION

The need for providing a connection system to a stationary motor vehicle in cold climates is well-known. More specifically, in very cold climates it is vital to either heat the engine oil or heat the engine block when main vehicle is parked for extended periods such as overnight. Failure to do so, particularly in very cold climates and particularly with diesel engines will cause great difficulty in starting the engine after any extended period of the engine not being operated.

Similarly, the batteries of electrically powered vehicles, including various hybrid vehicles, must be connected to a source of electric power when the vehicle is stationary. Recreational vehicles and tractor-trailers with so-called “sleeper boxes” accommodate a connection when the vehicle is parked that may include electric power, cable-television, satellite television, telephone connections and the like.

The prior art includes the use of one or more cables connecting to one or more ports on the vehicle and extending to one or more stationary utility sources. Often one or more cables extending from a source to the vehicle may be a tripping hazard for persons accessing the vehicle either for maintenance or any other purpose. The tripping hazard is most acute if the cable rests on the ground adjacent to the vehicle.

If one or more of these cables is slightly raised above the ground adjacent to the vehicle, the cable may block movement of personnel around the vehicle either for maintenance or to merely access the interior of the vehicle.

In many cases no part of the cable making the connection between the utility source and the vehicle may be visible to an operator seated in the driver's seat of the vehicle. This increases the risk that the vehicle operator may inadvertently attempt to move the vehicle without first disconnecting the cable connection and this may result in damage to the utility source, the cable and/or the vehicle. Elaborate breakaway connections are known to minimize this problem. See for example Meleek et al U.S. Pat. No. 7,070,417 issued Jul. 4, 2006. Some embodiments of the present invention minimize the need for such elaborate apparatus.

### SUMMARY OF THE INVENTION

It is an object of present invention to provide a system that minimizes the risk of tripping persons moving on or around the vehicle to which a connection is made.

Another object of the present invention is to provide a system that does not block movement of persons moving on or around the vehicle to which a connection is made.

Still another object of the present invention is to provide a system that provides a visual cue that there is a connection between the utility source in the vehicle before the vehicle is moved. More particularly, it is an object to ensure, at least in some embodiments of the present invention, that the vehicle operator will have an indication of an issue if the operator attempts to move the vehicle without disconnecting from the utility source.

It has now been found that these and other objects of the present invention may be achieved in a system for connecting an associated motor vehicle to a utility connection which includes a cable for connection to an associated utility connection having first and second axial extremities, a connector for the first axial extremity for connecting to an associated utility connection, a connector for the second axial extremity for connecting to an associated motor vehicle and an elongated flexible member cooperating with an axial section of the cable for supporting and positioning said cable.

### BRIEF DESCRIPTION OF THE DRAWING

The invention will be better understood by reference to the accompanying drawing

FIG. 1 is a diagrammatic representation of a truck-tractor in combination with one form of the connection system in accordance with the present invention.

FIG. 2 is a diagrammatic representation of the bundle illustrated in FIG. 1. This drawing shows the elements in spaced apart relationship for clarity of the diagrammatic illustration. In most embodiments these elements will be disposed in side abutting relationship.

### DESCRIPTION OF THE PREFERRED EMBODIMENTS

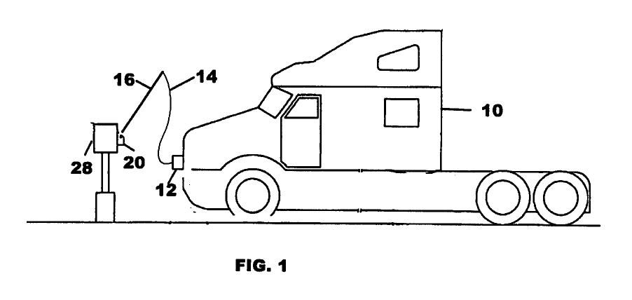

Referring now to the FIG. 1 there is shown a truck tractor 10 having a utility connection port 12 disposed at the front end thereof. Although the utility connection port 12 is shown at the front end of the vehicle in the drawing, those skilled in the art will recognize that although the drawing shows a truck tractor the invention has application to other vehicles including but not limited to other trucks, automobiles and recreational vehicles. Similarly, although the drawing shows a utility connection at the front of a vehicle, and we understood that the utility connection on the vehicle may be on either side or the rear or anywhere else on the vehicle. Often the front end of the vehicle is convenient. For example, vehicles parked in a garage or fleets of vehicles parked in a parking lot are often more readily accessible from the front of the vehicle. An additional advantage of having the utility connector disposed at the front of the vehicle is that the operator of the vehicle is much less likely to forget that there is any connection between the vehicle and a stationary utility housing.

The nature of the utility connection will vary with the particular application. Known apparatus provides for connection of electric power to engine oil or block heaters, battery recharging as well as utility connections for other electric power, cable-television, satellite television, telephone connections and the like.

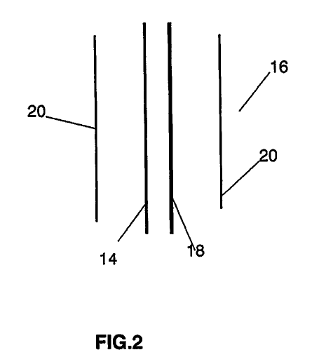

A cable 14 connects to the utility connection 12. An axial portion of the cable is a part of a bundle 16. As shown in FIG. 2 the bundle 16 includes and an elongated flexible member 18 an axial part of the the cable 14 surrounded by an elongated shrink wrap tube 20. The lower (as viewed) axial extremity of the bundle 16 is fixed to a housing 28 by a connector 20 that is fixed to the ground. In a preferred embodiment the flexible member 18 is fiberglass. As will be apparent from the drawing, maintenance personnel may move freely about the vehicle to perform maintenance work without interference from the cable. The placement of the housing 28 proximate to the front of the vehicle and the vehicle having the connector 12 at the front of the vehicle is particularly advantageous. More specifically, this arrangement minimizes the rest of the operator of a vehicle not realizing connection that must be disconnected before moving vehicle. In addition there is the additional advantage that the length of the cable 14 is minimized.

The bundle 16 may be inclined with respect to both vertical and horizontal axes or may even be horizontal or vertical in some embodiments of the present invention. In some embodiments the bundle 16 may have a length of 5 or 6 feet. The length of the bundle 12 will vary with the specific application.

The term “motor vehicle” as used herein includes but is not limited to cars, trucks, truck-tractors, hybrid vehicle including plug-in hybids. Those skilled in the art will recognize that a plug-in hybrid car is similar to a conventional hybrid vehicle—both use a gasoline engine as well as an electric motor. However, a plug-in hybrid uses larger battery packs that can be recharged by connecting to common household electricity.

The term “utility connection” includes connections to supply electric power to engine oil and engine block heaters as well as electric power for battery charging as weel as cable-television, satellite television, telephone connections and the like.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A system for connecting an associated motor vehicle to a utility connection which comprises:
a cable for connection to an associated utility connection having first and second axial extremities;
a connector for said first axial extremity for connecting to an associated utility connection;
a connector for said second axial extremity for connecting to an associated motor vehicle. an elongated flexible member cooperating with an axial section of said cable for supporting and positioning said cable.

2. The system as described in claim 1 wherein said axial section and said cable are surrounded by sleeve.

3. The system as described in claim 2 wherein said sleeve is a shrink wrap sleeve.

4. The system as described in claim 1 wherein said flexible member is disposed in oblique relationship to the surrounding ground.
